(19) United States
(12) Patent Application Publication
(10) Pub. No.: US 2024/0132687 A1
(43) Pub. Date: Apr. 25, 2024

(54) Thermally expandable compositions comprising wax

(71) Applicant: Henkel AG & Co. KGaA, Düsseldorf (DE)

(72) Inventors: Michael Klotz, Düsseldorf (DE); Klaus Rappmann, Weinheim-Rittenweier (DE); Ralf Sauer, St.Leon-Rot (DE); Fiona Cappel, Rauenberg (DE)

(21) Appl. No.: 18/390,596

(22) Filed: Dec. 20, 2023

Related U.S. Application Data
(63) Continuation of application No. PCT/EP22/66800, filed on Jun. 21, 2022.

(30) Foreign Application Priority Data
Jul. 6, 2021 (EP) 21183864.4

(51) Int. Cl. C08J 9/00; C08J 9/10

(52) U.S. Cl. CPC C08J 9/0009; C08J 9/0023; C08J 9/103; C08J 9/105; C08J 2201/026; C08J 2323/08

(57) ABSTRACT

The present application relates to a thermally expandable composition which contains at least one peroxidically cross-linking polymer, at least one peroxide, at least one blowing agent and at least one wax, to molded bodies containing said composition, and to a method for sealing and filling voids in components, for strengthening or reinforcing components, in particular hollow components, and for bonding mobile components, using molded bodies of this type.

The present application relates to a thermally expandable composition which contains at least one peroxidically cross-linking polymer, at least one peroxide, at least one blowing agent and at least one wax, to molded bodies containing said composition, and to a method for sealing and filling voids in components, for strengthening or reinforcing components, in particular hollow components, and for bonding mobile components, using molded bodies of this type.

Modern vehicles and vehicle parts have a large number of voids which have to be sealed to prevent the entry of moisture and dirt, since otherwise this can lead to corrosion of the corresponding body parts from the inside out. This applies in particular to modern self-supporting body structures in which a heavy frame construction is replaced by lightweight, structurally stable frameworks made of prefabricated void profiles. As a result of this system, structures of this kind have a series of voids that have to be sealed against the ingress of moisture and dirt. Seals of this kind are also used for the purpose of preventing the transmission of airborne sound in voids of this kind, and thus to reduce unpleasant vehicle running noises and wind noises and thus to increase the driving comfort in the vehicle.

Baffle parts that cause a sealing and/or acoustic effect in voids of this kind are often referred to as “pillar fillers,” “baffles” or “acoustic baffles.” They usually consist either completely of thermally expandable shaped bodies or of molded bodies containing a carrier and expandable polymeric compositions in the peripheral region thereof. These baffle parts are fastened to the open structures by means of hanging, clipping, gluing, screwing or welding during body assembly. After closing the structures during body assembly and further pretreating the body, the process heat of the furnaces for curing the cathodic dip paint is then used to trigger the expansion of the expandable part of the baffle part in order to thus seal the cross section of the void.

Moreover, in modern vehicles, there is an increasing need for metal and/or plastics-based lightweight components for dimensionally consistent batch production with predetermined rigidity and structural strength. In vehicle construction in particular, as a result of the desire to reduce weight, there is a need for metal lightweight components consisting of thin-walled sheets which still have adequate rigidity and structural strength. Molded bodies made of thermally expandable compositions which impart the necessary support properties are also used in this case.

Corresponding thermally expandable compositions are described, for example, in the publications WO 2008/034755, WO 2007/039309, WO 2013/017536, German application 10 2012 221 192.6 and also WO 2017/055330, WO 2017/055329, WO 2017/108809 and WO 2018/234368. These thermally expandable compositions are also used in the automotive sector.

Nowadays, exothermic blowing agents such as ADCA (azodicarbonamide), OBSH (4,4′-oxybis(benzenesulfonyl hydrazide)), DNPT (dinitroso pentamethylene tetramine), PTSS (p-toluene semicarbazide), BSH (benzene-4-sulfonohydrazide), TSH (toluene-4-sulfonohydrazide), 5-PT (5-phenyltetrazole) and the like are used in expandable compositions of this kind, such as rubber vulcanizates (sulfur, peroxide or benzoquinone dioxime) for sealing and bonding, ethylene vinyl acetate-based void partitions, epoxy-based supporting foams and expandable sealants in automotive manufacturing.

In general, blowing agents, in particular chemical blowing agents which are used in expandable molded parts for automotive construction, are susceptible to moisture. Moisture can change the gas volume and the gas release. As a result, the coordinated system of polymer and blowing agent becomes unbalanced and the desired expansion rates are no longer achieved. This leads to leaks during subsequent use on the vehicle. The exposure of the compositions to moisture occurs in particular during transport and storage, with the user requirements for the stability and water vapor resistance of the products becoming ever greater due to the increasingly global logistics structure.

The problem addressed by the present invention was therefore that of providing thermally expandable compounds which are suitable in the same way as the known compounds for the uses described above but, at the same time, have a significantly improved water vapor resistance.

Surprisingly, this object is achieved by thermally expandable compositions which contain, based on the total weight of the composition,
a) 40.0 to 98.0 wt. % of at least one peroxidically cross-linking polymer,
b) 0.05 to 5 wt. % of at least one peroxide,
c) 1.0 to 15.0 wt. % of at least one blowing agent, and
d) 0.1 to 10 wt. % of at least one wax,
wherein the at least one peroxidically cross-linking polymer has a melt flow index (MFI) of 0.3 to 10 g/10 min and is selected from styrene-butadiene block copolymers, styrene-isoprene block copolymers, ethylene-vinyl acetate copolymers, functionalized ethylene-vinyl acetate copolymers, functionalized ethylene-butyl acrylate copolymers, ethylene-propylene-diene copolymers, ethylene-methyl acrylate copolymers, ethylene-ethyl acrylate copolymers, ethylene-butyl acrylate copolymers, ethylene (meth)acrylic acid copolymers, ethylene-2-ethylhexyl-acrylate copolymers and ethylene-acrylic ester copolymers, in particular from ethylene-vinyl acetate copolymers and functionalized ethylene-vinyl acetate copolymers.

Corresponding compositions overcome the known disadvantages and at the same time meet the requirements placed on such thermally expandable compositions to a high degree, especially with regard to excellent expansion and low water absorption. In particular, high resistance to water vapor is achieved.

The present invention therefore firstly relates to thermally expandable compositions containing, based on the total weight of the composition,
a) 40.0 to 98.0 wt. % of at least one peroxidically cross-linking polymer,
b) 0.05 to 5 wt. % of at least one peroxide,
c) 1.0 to 15.0 wt. % of at least one blowing agent, in particular at least one chemical blowing agent, and
d) 0.1 to 10 wt. % of at least one wax,
wherein the at least one peroxidically cross-linking polymer has a melt flow index (MFI) of 0.3 to 10 g/10 min and is selected from styrene-butadiene block copolymers, styrene-isoprene block copolymers, ethylene-vinyl acetate copolymers, functionalized ethylene-vinyl acetate copolymers, functionalized ethylene-butyl acrylate copolymers, ethylene-propylene-diene copolymers, ethylene-methyl acrylate copolymers, ethylene-ethyl acrylate copolymers, ethylene-butyl acrylate copolymers, ethylene (meth)acrylic acid copolymers, ethylene-2-ethylhexyl-acrylate copolymers and ethylene-acrylic ester copolymers, in particular from ethylene-vinyl acetate copolymers and functionalized ethylene-vinyl acetate copolymers.

As an essential component, the thermally expandable composition contains at least one peroxidically cross-linkable polymer a) as a binder system. A person skilled in the art uses the expression “peroxidically cross-linkable” to refer to (thermoplastic) polymers and elastomers in which a hydrogen atom can be abstracted from the main chain or a side chain by the action of a radical initiator, such that a radical is left behind that acts on other polymer chains in a second reaction step.

According to the present invention, the at least one peroxidically cross-linkable polymer a) is selected from styrene-butadiene block copolymers, styrene-isoprene block copolymers, ethylene-vinyl acetate copolymers, functionalized ethylene-vinyl acetate copolymers, functionalized ethylene-butyl acrylate copolymers, ethylene-propylene-diene copolymers, ethylene-methyl acrylate copolymers, ethylene-ethyl acrylate copolymers, ethylene-butyl acrylate copolymers, ethylene-(meth)acrylic acid copolymers, ethylene-2-ethylhexyl acrylate copolymers, and ethylene-acryl ester copolymers.

According to the invention, a “functionalized copolymer” is understood to be a copolymer which is provided with additional hydroxide groups, amine groups, carboxyl groups, anhydride groups and/or acrylate groups.

Within the meaning of the present invention, ethylene-vinyl acetate copolymers, functionalized ethylene-vinyl acetate copolymers, functionalized ethylene-butyl acrylate copolymers, ethylene-propylene-diene copolymers, styrene-butadiene block copolymers, styrene-isoprene block copolymers, ethylene-methyl acrylate copolymers, ethylene-ethyl acrylate copolymers, ethylene-butyl acrylate copolymers and ethylene-(meth)acrylic acid copolymers are particularly advantageous. Ethylene-vinyl acetate copolymers and functionalized ethylene-vinyl acetate copolymers, in particular ethylene-vinyl acetate copolymers, which contain no further monomer units in polymerized form (pure ethylene-vinyl acetate copolymers) are very particularly preferred.

Thermally expandable preparations which contain at least one ethylene—vinyl acetate copolymer having a vinyl acetate proportion of from 5 to 30 wt. %, in particular from 10 to 25 wt. %, more particularly from 15 to 20 wt. %, based on the total mass of the copolymers, are particularly preferred according to the invention.

According to the invention, the peroxidically cross-linkable polymer a), in particular the ethylene-vinyl acetate copolymer, has a melt flow index (MFI) of 0.3 to 10 g/10 min, in particular of 0.5 to 10 g/10 min, more preferably with a melt flow index of 1.0 to 10 g/10 min or of 1.5 to 8 g/10 min, very particularly preferably of 1.5 to 5 g/10 min. According to the invention, it can be advantageous for two or more polymers having different melt flow indices to be used in the thermally expandable preparations. It is preferred according to the invention that the proportion of further peroxidically cross-linkable polymers which do not meet the above requirements in the composition is<20 wt. %, more preferably<15 wt. %, based on the total weight.

For this purpose, the melt flow index is determined in a capillary rheometer, the polymer being melted at 190° C. in a heatable barrel and being pushed through a defined extruder die (capillary) at a pressure produced by the bearing load (2.16 kg) (ASTM D1238). The mass of material being extruded is measured as a function of time. Unless otherwise indicated, all melt indices specified herein are those which were determined by means of ASTM D1238 at 190° C. and 2.16 kg.

In a preferred embodiment, as for low-temperature expanding formulations, the polymers a) have a melting point (determinable by DSC according to ASTM D3417) below the decomposition temperature of the blowing agent. Polymer a) preferably has a melting point below 100° C., preferably between 90 and 60° C.

The thermally expandable preparations preferably contain at least 40 wt. % and preferably at most 98 wt. %, in particular at least 50 and at most 97 wt. % of at least one peroxidically cross-linkable polymer, preferably of an ethylene-vinyl acetate copolymer. Thermally expandable preparations that contain 50 to 95 wt. %, in particular 60 to 95 wt. %, preferably 70 to 95 wt. %, of at least one ethylene-vinyl acetate copolymer, in each case based on the total mass of the thermally expandable preparation, are particularly preferred. The minimum amount can also be 55, 65 or 75 wt. % and the maximum amount at 94, 93, 92, 91, 90, 89, 88, 87, 86 or 85 wt. %.

In various embodiments, a mixture of at least two polymers is used as polymer a), wherein the first polymer does not contain glycidyl (meth)acrylate as a monomer in polymerized form and is preferably selected from those described above, and the second polymer does contain glycidyl (meth)acrylate as a monomer in polymerized form. The term “(meth)acrylate”, as used herein, in each case comprises the corresponding acrylates and methacrylates.

In various embodiments the thermally expandable compositions contain at least one second peroxidically cross-linkable polymer which contains glycidyl (meth)acrylate as a monomer in polymerized form in a proportion of 2 to 20 wt. %, based on the particular polymer. The glycidyl (meth)acrylate in this polymer is 2 to 20 wt. %, in particular 3 to 15 wt. %, preferably 6 to 10 wt. %, based on the total mass of the copolymers. This second peroxidically cross-linkable polymer is different from the first peroxidically cross-linkable polymer and is additionally contained. These polymers preferably contain glycidyl methacrylate. The peroxidically cross-linkable polymers described above are suitable as such polymers, with the polymers containing glycidyl (meth)acrylate as a unit. Particularly preferred are terpolymers which, in addition to glycidyl (meth)acrylate as a unit, preferably contain monomers selected from the group of ethylene, propylene, acrylic esters, such as preferably methyl (meth)acrylate, ethyl (meth)acrylate, propyl (meth)acrylate or butyl (meth)acrylate, styrene and vinyl acetate. Ethylene-(meth)acrylic (ester)-glycidyl (meth)acrylate terpolymers, in particular ethylene-methyl (meth)acrylate-glycidyl methacrylate and ethylene-butyl (meth)acrylate-glycidyl methacrylate, are very particularly preferred. Furthermore, it has proven to be advantageous if the melt flow index of this polymer, in particular of the terpolymer, is from 0.3 to 30 g/10 min, in particular from 0.5 to 25 g/10 min. Polymers, in particular terpolymers, having a melt flow index of 1.5 to 25 g/10 min, in particular 2 to 15 g/10 min, are particularly advantageous.

In a preferred embodiment, as for low-temperature expanding formulations, these polymers which contain glycidyl (meth)acrylate monomers in polymerized form have a melting point (determinable by DSC according to ASTM D3417) below the decomposition temperature of the blowing agent. The polymer preferably has a melting point below 100° C., preferably between 90 and 60° C., particularly preferably between 80 and 65° C.

According to the invention, it can be advantageous for two or more, in particular two different, polymers which contain glycidyl (meth)acrylate monomers in polymerized form to be used in the thermally expandable preparations. Two different terpolymers can be particularly advantageous for improving the water absorption.

The thermally expandable preparations in such embodiments can preferably contain at least 2 wt. %, and preferably a maximum of 10 wt. %, in particular a maximum of 8 wt. %, of at least one polymer which contains glycidyl (meth)acrylate as a monomer in polymerized form in a proportion of 2 to 20 wt. %, based on the particular polymer, in particular of at least one terpolymer. Thermally expandable preparations containing from 2 to 8 wt. %, in particular from 3 to 7 wt. %, of at least one peroxidically cross-linkable polymer containing glycidyl (meth)acrylate as monomer in polymerized form, in each case based on the total mass of the thermally expandable preparation, are particularly preferred.

In this case, the preparations additionally preferably contain at least one ethylene-vinyl acetate copolymer in the amounts specified above.

In addition to the peroxidically cross-linkable polymers described above, the thermally expandable preparations may also preferably contain at least one low-molecular-weight multifunctional acrylate.

A “low-molecular-weight multifunctional acrylate” is understood to be a compound which has at least two acrylate groups and a molar weight of below 2,400 g/mol, preferably below 800 g/mol. In particular, compounds that have two, three or more acrylate groups per molecule have been found to be advantageous.

Preferred difunctional acrylates are ethylene glycol dimethacrylate, diethylene glycol dimethacrylate, triethylene glycol dimethacrylate, triethylene glycol diacrylate, tripropylene glycol dimethacrylate, 1,4-butanediol-dimethacrylate, 1,3 butylene glycol dimethacrylate, 1,3-butanediol dimethacrylate, tricyclodecane dimethanol dimethacrylate, 1,10-dodecanediol dimethacrylate, 1,6-hexanediol dimethacrylate, 2-methyl-1,8-octanediol dimethacrylate, 1,9-nonanediol dimethacrylate, neopentyl glycol dimethacrylate and polybutylene glycol dimethacrylate.

Preferred low-molecular-weight acrylates having three or more acrylate groups are glycerol triacrylate, dipentaerythritol hexaacrylate, pentaerythritol triacrylate (TMM), tetramethylolmethane tetraacrylate (TMMT), trimethylolpropane triacrylate (TMPTA), pentaerythritol trimethacrylate, di(trimethylolpropane) tetraacrylate (TMPA), pentaerythritol tetraacrylate, trimethylolpropane trimethacrylate (TMPTMA), tri(2-acryloxyethyl)isocyanurate and tri(2-methacryloxyethyl)trimellitate and the ethoxylated and propoxylated derivatives thereof having a content of a maximum of 35 EO units and/or a maximum of 20 PO units.

According to the invention, thermally expandable preparations that contain one or more low-molecular-weight multifunctional acrylates selected from triethylene glycol diacrylate, triethylene glycol dimethacrylate, tricyclodecane dimethanol dimethacrylate (TCDDA), trimethylolpropane triacrylate (TMPTA) and trimethylolpropane tri methacrylate (TMPTMA), pentaerythritol triacrylate (TMM), tetramethylolmethane tetraacrylate (TMMT), pentaerythritol tri methacrylate, di(trimethylolpropane)tetraacrylate (TMPA) and pentaerythritol tetraacrylate are very particularly preferred. Very particular preference is given to those which contain TCDDA and/or TMPTA, in particular both.

In addition to the low-molecular acrylates, the thermally expandable preparations may contain further co-cross-linking agents, such as allyl compounds, for example triallyl cyanurate, triallyl isocyanurate, triallyl trimesate, triallyl trimellitate (TATM), tetraallyl pyromellitate, the diallyl esters of 1,1,3-trimethyl-5-carboxy-3-(4-carboxyphenyl)indene, trimethylolpropane trimellitate (TMPTM) or phenylene dimaleimide.

The co-cross-linking agents, preferably the low-molecular-weight multifunctional acrylates, are contained in the thermally expandable preparations preferably in an amount of from 0.2 to 2.5 wt. %, in particular from 0.4 to 1.4 wt. %, based in each case on the total weight of the thermally expandable preparation.

As a curing agent system for the peroxidically cross-linkable polymers, the thermally expandable preparations contain at least one peroxide b). In particular, organic peroxides are suitable, for example ketone peroxides, diacyl peroxides, peresters, perketals and hydrogen peroxides. Particularly preferred are, for example, cumene hydroperoxide, t-butyl peroxide, bis(tert-butylperoxy)diisopropylbenzene, di(tert-butylperoxyisopropyl)benzene, dicumyl peroxide, t-butyl peroxybenzoate, dialkyl peroxydicarbonate, diperoxy ketals (e.g., 1,1-di-tert-butylperoxy-3,3,5-trimethylcyclohexane), ketone peroxides (e.g., methyl ethyl ketone peroxides), 4,4-di-tert-butylperoxy-n-butyl valerates and trioxepanes (e.g., 3,3,5,7,7-pentamethyl-1,2,4-trioxepane).

Peroxides commercially marketed for example by Akzo Nobel or Pergan, such as 3,3,5,7,7-pentamethyl-1,2,4-trioxepane, 2,5-dimethyl-2,5-di(tert-butylperoxy)hexane, di-tert-butyl peroxide, 2,5-dimethyl-2,5-di(tert-butylperoxy)hexane, tert-butyl cumyl peroxide, di-(2-tert-butylperoxyisopropyl)benzene, dicumyl peroxide, butyl-4,4-di(tert-butylperoxi)valerate, tert-butylperoxy-2-ethyl hexyl carbonate, 1,1-di-(tert-butylperoxy)-3,3,5-trimethylcyclohexane, tert-butyl peroxybenzoate, di-(4-methylbenzoyl)peroxide and dibenzoyl peroxide, are particularly preferred.

It has also been found to be advantageous for the peroxides used to be substantially inert at room temperature and to be activated only when heated to relatively high temperatures (for example when heated to temperatures of between 130° C. and 240° C.). It is particularly advantageous for the peroxide used to have a half-life of more than 60 minutes at 65° C., i.e. after the thermally expandable preparation containing the peroxide has been heated to 65° C. for 60 minutes, less than half of the peroxide used has decomposed. According to the invention, peroxides that have a half-life of 60 minutes at 115° C., in particular 130° C., may be particularly preferred.

At least one peroxide is particularly preferably selected from the group consisting of di(tert-butylperoxyisopropyl)benzene, dicumyl peroxide, 1,1-di-(tert-butylperoxy)-3,3,5-trimethylcyclohexane, 2,5-dimethyl-2,5-di(tert-butylperoxy)hexane, dibenzoyl peroxide and di-tert-butyl-1,1,4,4-tetramethylbut-2-in-1,4-ylene diperoxide.

According to the invention, it is also advantageous for at least one peroxide or the peroxides to be used in a form in which they are applied to a solid inert carrier, such as calcium carbonate and/or silica and/or kaolin.

Preferably, the peroxide is selected such that the cross-linking temperature T90 is below, preferably at least 15-35° C. below, the decomposition temperature of the contained blowing agent. This ensures a high gas yield and thus a high degree of expansion of the material. The cross-linking temperature T90 is defined as the temperature at which 90% of the cross-linking of the material is achieved within 12 minutes. The decomposition temperature of the blowing agent indicates the temperature at which the blowing agent begins to decompose, which can also be referred to as the activation temperature. The cross-linking temperature T90 and the degree of cross-linking can be determined by means of a rheometer measurement, as with a Monsanto Rheometer 100 S (principle: oscillating disc at a deflection angle of 3°, approx. 15 cm³ chamber volume) according to DIN 53529.

The at least one peroxide or the peroxides is/are contained in the thermally expandable preparations according to the invention in an amount of from 0.05 to 5 wt. %, particularly preferably in an amount of from 0.1 to 3 wt. %, in particular in an amount of from 0.2 to 2 wt. % or 0.3 to 1 wt. %, in each case determined as the active substance content of peroxide based on the total mass of the thermally expandable preparation.

The blowing agents c) used may be the known blowing agents, in particular advantageously chemical blowing agents are used for such compositions, in particular the exothermic blowing agents already mentioned above, such as ADCA (azodicarbonamide), OBSH (4,4′-oxybis(benzenesulfonyl hydrazide)), DNPT (dinitrosopentamethylenetetramine), PTSS (p-toluene semicarbazide), BSH (benzene-4-sulfonohydrazide), TSH (toluene-4-sulfonohydrazide), 5-PT (5-phenyltetrazole), and the like.

Alternatively, endothermic chemical blowing agents can also be used, as described, for example, in international patent publications WO 2017/055330, WO 2017/055329, WO 2017/108809 and WO 2018/234368.

A chemical blowing agent is understood, according to the invention, to mean compounds which decompose upon exposure to heat and thereby release gases.

The blowing agents can also contain further additives, such as in particular calcium oxide, zeolites, zinc oxide and/or magnesium oxide.

In various embodiments, the thermally expandable compositions contain the blowing agent in an amount of from 1.0 to 15.0 wt. %, preferably 1.5 to 12.0 wt. %, preferably 2.0 to 10.0 wt. %, based on the total composition. Unless indicated otherwise, the amounts in wt. % given here are based on the total composition prior to expansion.

The thermally expandable preparations contain, in various embodiments, ADCA (azodicarbonamide) and/or OBSH as blowing agent.

Finally, the thermally expandable compositions also contain at least one wax d).

Suitable waxes include, but are not limited to, paraffinic waxes with melting temperatures in the range of from 45 to 70° C., microcrystalline waxes with melting temperatures in the range of from 60 to 95° C., synthetic Fischer-Tropsch waxes with melting temperatures (solidification points) in the range from 90 to 115° C. and polyethylene waxes with melting temperatures between 85 and 140° C.

Suitable paraffin waxes are, for example, those available from Sasol under the product names SASOLWAX 5603, 6203 and 6805.

An example of a suitable microcrystalline wax is Sasolwax 3971 from Sasol.

Exemplary polyethylene waxes include ethylene homopolymers as available, for example, from Backer Petrolite Corp. as POLYWAX™500, POLYWAX™1500 and POLYWAX™2000.

However, Fischer-Tropsch waxes with solidification points in the range of from 90 to 105° C., in particular 95 to 105° C., and drip points in the range of from 110° to 120° C. (according to DGF M-III 3) are particularly suitable for the compositions of the invention. Such waxes are available, for example, from Deurex, for example as Deurex® T 39 (for example T 39 G).

In various embodiments, the thermally expandable compositions contain the wax in an amount of from 0.1 to 10.0 wt. %, preferably 0.4 to 8.0 wt. %, preferably 0.8 to 9.0 wt. %, even more preferably 1.0 to 8.0 wt. %, based on the total composition.

In addition to the above-mentioned constituents, the thermally expandable compounds may contain further conventional components, such as fillers, plasticizers, reactive diluents, rheology auxiliary agents, wetting agents, adhesion promoters, anti-ageing agents, stabilizers, and/or dye pigments. These further components are typically present in the composition in amounts of a total of 0.01 to 60, typically up to 15 wt. %, preferably 0.1 to 10 wt. % or 0.5 to 10 wt. %.

Examples of suitable plasticizers are alkyl esters of dibasic acids (e.g., phthalate esters, adipic acid polyesters), technical white and process oils (paraffins), diaryl ethers, benzoates of polyalkylene glycols, citric acid esters (e.g., triethyl citrate), organic phosphates and alkyl sulfonic acid esters of phenol or kresol.

Fillers include, for example, the various ground or precipitated chalks, calcium magnesium carbonates, talc, graphite, barite, silicic acid or silica and in particular silicate fillers such as mica, for example in the form of chlorite, or silicate fillers of the aluminum-magnesium-calcium silicate type, for example wollastonite. Talc is a particularly preferred filler. The fillers are preferably coated, preferably with stearic acid or stearates. This positively influences the trickling behavior.

The fillers are preferably used in an amount of from 0 to 60 wt. %, in particular from 0 to 15 wt. %, preferably 2 to 10 wt. %, particularly preferably 3 to 8 wt. %, in each case based on the mass of the entire thermally expandable composition.

Chromophoric components, in particular black dyes based on graphite and/or carbon black, are contained in the thermally expandable compositions according to the invention preferably in an amount of from 0 to 2 wt. %, in particular from 0.1 to 0.8 wt. %, very particularly preferably 0.15 to 0.5 wt. %, in each case based on the mass of the entire thermally expandable composition.

It is possible to use, as antioxidants or stabilizers, for example, sterically hindered phenols or mixtures thereof and/or sterically hindered thioethers and/or sterically hindered aromatic amines, diphosphonites, disulfides, for example bis-(3,3-bis-(4′-hydroxy-3-tert-butylphenyl)butanoic acid)glycol ester or also 4-methylphenol, reaction product with dicyclopentadiene and isobutylene (Wingstay L).

Antioxidants or stabilizers are preferably contained in the thermally expandable compositions according to the invention in an amount of from 0 to 5 wt. %, in particular from 0.1 to 2 wt. %, preferably from 0.1 to 0.5 wt. %, in each case based on the mass of the entire thermally expandable composition.

Desiccants, such as calcium oxide and/or zeolites, are preferably contained in the thermally expandable compositions according to the invention in an amount of from 0-5 wt. %, in particular from 0.1 to 2.5 wt. %, in each case based on the mass of the entire thermally expandable composition.

The thermally expandable compositions according to the invention are preferably formulated such that they are solid at 22° C. A thermally expandable composition is referred to as “solid” according to the invention if the geometry of this composition does not deform under the influence of gravity at the indicated temperature within 1 hour, in particular within 24 hours.

The thermally expandable compositions according to the invention can be prepared by mixing the selected components in any suitable mixer, such as a kneader, a double-Z kneader, an internal mixer, a twin-screw mixer, a continuous mixer, or an extruder, in particular a twin-screw extruder.

Although it may be advantageous to slightly heat the components to facilitate achieving a homogeneous and uniform compound, care has to be taken to ensure that temperatures which cause activation of the curing agents, the accelerators and/or the blowing agent are not reached. The resulting thermally expandable composition can be shaped immediately after its preparation, for example by blow molding, pelletizing, injection molding, compression molding, stamping or extrusion.

In a particularly preferred embodiment, the blowing agent c) and preferably also the wax d) and the peroxide b) are introduced as a “master batch” into the thermally expandable composition. The master batch is understood to mean a premix of the blowing agent to be used, for example with a polymer, for example the used polymers a) or another polymer. In various embodiments, this polymer can comprise the above-described acrylates, in particular the polymer which contains glycidyl (meth)acrylate as monomer in polymerized form, and/or the low-molecular-weight multifunctional acrylates. In addition, this master batch can also contain an EVA copolymer which has a higher melt flow index than stated for the polymer a), for example in the range of>100 g/10 min, for example 400-600 g/10 min. Such EVA copolymers can contain amounts of up to 30 wt. % vinyl acetate monomer.

Such a (reactive) master batch is then combined/mixed with the base polymer a). Typical weight ratios of master batch base polymer are in the range of 40:60 to 5:95, for example 25:75 or 20:80 to 8:92.

In addition to the procedural advantages, this approach has the advantage that the blowing agent can be distributed particularly homogeneously and gently and less heat is generated by the kneading/mixing. The blowing agent can thus be protected from unwanted decomposition. Particular preference is given to a master batch comprising the at least one blowing agent c), the at least one peroxide b), the at least one wax d), and optionally a part of the peroxidically cross-linkable polymer a), in particular the above-mentioned acrylate components, optionally in combination with an EVA copolymer having a higher melt flow index. In addition, the master batch can also contain further components, such as talc and/or antioxidants.

The thermally expandable composition is expanded by heating, the composition being heated for a specific time to a specific temperature sufficient to cause the activation of the blowing agent. Depending on the constituents of the composition and the requirements of the production line, these temperatures are usually in the range of from 110° C. to 240° C., preferably 120° C. to 210° C., with a residence time of from 10 to 90 minutes, preferably from 5 to 60 minutes.

In the field of vehicle construction, it is particularly advantageous for the compositions according to the invention to expand when the vehicle passes through the furnace for hardening the cathodic dip coating, and therefore a separate heating step can be omitted.

The thermally expandable compositions of the present invention can be used in a wide range of support, filling, sealing, and adhesive applications, for example in the field of baffle parts for sealing voids in vehicles. However, it is also conceivable to use said compositions as a lining adhesive, for example in the door or roof region. For an intended use of this kind, the thermally expandable compositions according to the invention can be applied by means of direct extrusion. However, the compositions can also be brought in extruded form onto the application site, pressed thereon by heating the steel, and melted. As a third alternative, application as a co-extrudate is also conceivable. In this embodiment, according to the invention, a second adhesive composition is applied in a thin layer under the actual non-adhesive shaped part made of the thermally expandable composition according to the invention. In the context of this embodiment, this second adhesive layer is used to fix the shaped part during shell construction.

Accordingly, the thermally expandable compositions are particularly suitable for producing molded bodies, in particular baffle parts for sealing voids, i.e., for producing parts which are inserted into the voids of vehicles, then expand by heating and simultaneously cure, and in this way seal the void as intended or as completely as possible.

The present invention secondly relates accordingly to a molded body which has a thermally expandable composition according to the invention. This can be, for example, a baffle part for sealing voids of a component which has a shape that is adapted to the void.

According to the invention, a “shape that is adapted to the void” is in this case understood to mean all geometries of baffle parts that ensure that the void is sealed as intended or completely after expansion. In this case, the shape of the baffle part can be individually modeled on the shape of the void and have corresponding tips and/or curves; however, in the case of the thermally expandable compositions according to the invention which have high degrees of expansion, introducing a correspondingly large amount in a variable form, for example in the form of a bead or a cut strand of the material, into the void can also be sufficient to ensure that the void is sealed as intended or completely after expansion.

Baffle parts of this kind are usually produced from the thermally expandable compositions according to the invention by means of injection molding techniques. The thermally expandable compositions are in this case heated to temperatures in the range of from 70 to 120° C. and then injected into a correspondingly shaped mold.

The molded bodies according to the invention can be used in all products which have voids. In addition to vehicles, these include aircraft, rail vehicles, domestic appliances, furniture, buildings, walls, partitions or boats, for example.

The present invention also relates to a method for sealing and filling voids in components, for strengthening or reinforcing components, in particular hollow components, and for adhesively bonding mobile components using the compositions and molded bodies described herein. The method is preferably also a method for sealing voids in a component, a baffle part according to the invention being introduced into the void and then heated to a temperature above 130° C. such that the thermally expandable composition expands and seals the void.

The present invention also relates to the use of a molded body or baffle part according to the invention for acoustically sealing voids in components and/or for sealing voids in components against water and/or moisture.

The present invention also relates to the use of a molded body according to the invention for strengthening or reinforcing components, in particular hollow components.

The following examples are intended to explain the invention in greater detail; the selection of the examples should not limit the scope of the subject of the invention. In the compositions, all stated amounts are parts by weight unless indicated otherwise.

### EMBODIMENTS

### General Test Procedure/Preparation of the Formulations

To produce the thermally expandable preparations according to the invention, all reactive components, for example blowing agents, peroxides, activators and antioxidants, and also the wax, fillers at below 70° C. were added as a master batch to the EVA base polymer and slowly kneaded down until the preparation was homogeneously mixed. The master batch further contained the glycidyl acrylate-containing terpolymer, the multifunctional acrylates and an EVA copolymer with a melt flow index in the range of 400-600 g/10 min.

### Determination of Expansion

To determine the expansion, test specimens having the dimensions of approx. 20 mm×20 mm×3 mm were cut from the manufactured plates of the example formulations, these were introduced into a convection oven, which was heated to 175° C. (heating time approx. 7 to 10 min) and the test specimens were then left at this temperature for the period mentioned in the tables (including heating time). The expansion at 175° C. corresponds to the average conditions that are achieved during curing in vehicle construction.

The degree of expansion [%] was determined by the water displacement method according to the formula

$$Expansion = \frac{( m 2 - m 1 )}{m 1} \times 100$$

m1=mass of the test specimen in its original state in deionized water
m2=mass of the test specimen determined after baking in deionized water

### Determination of the Water Vapor Resistance

To determine the water vapor resistance, the compositions were stored before the expansion at 40° C. and 98% relative atmospheric humidity for up to 34 days and then the expansion was determined after different storage times.

TABLE 1
Example formulations (all amounts in parts by weight)

| | V1 | V2 | E1 | E2 | E3 | E4 | E5 | E6 |
|---|---|---|---|---|---|---|---|---|
| Substance name/ | | | | | | | | |
| group (generic names) | | | | | | | | |
| EVA polymer 1 | 80.0 | 80.0 | 92.0 | 80.0 | 80.0 | 80.0 | 80.0 | 60.0 |
| Peroxide | 1.00 | 0.50 | 0.40 | 0.50 | 0.50 | 0.50 | 0.50 | 2.00 |
| Blowing agent | 4.80 | 4.90 | 1.92 | 4.90 | 4.90 | 4.90 | 4.90 | 9.60 |
| Wax | 0 | 0 | 0.72 | 3.59 | 5.00 | 2.50 | 1.00 | 3.58 |
| EVA polymer 2 | 2.56 | 4.56 | 1.02 | 4.56 | 4.56 | 4.56 | 4.56 | 5.12 |
| Terpolymer | 4.97 | 4.97 | 1.99 | 4.97 | 4.97 | 4.97 | 4.97 | 9.93 |
| Co-cross-linking | 0.10 | 0.05 | 0.04 | 0.05 | 0.05 | 0.10 | 0.05 | 0.20 |
| agent 1 | | | | | | | | |
| Co-cross-linking | 0.03 | 0.03 | 0.01 | 0.03 | 0.03 | 0.03 | 0.03 | 0.06 |
| agent 2 | | | | | | | | |
| Zinc oxide | 0.90 | 0.90 | 0.36 | 0.90 | 0.90 | 0.90 | 0.90 | 1.80 |
| Antioxidant | 0.30 | 0.30 | 0.12 | 0.30 | 0.30 | 0.30 | 0.30 | 0.60 |
| Talc | 3.35 | 0 | 1.34 | 0 | 0 | 0 | 0 | 6.71 |
| Dye | 0.20 | 0.20 | 0.08 | 0.20 | 0.20 | 0.20 | 0.20 | 0.40 |
| TOTAL | 98.21 | 96.41 | 100 | 100 | 101.41 | 98.96 | 97.41 | 100 |
| Change Expansion in % (after | | | | | | | | |
| storage compared to day 0) | | | | | | | | |
| Day 3 | −6.6 | −6.3 | −1.3 | −0.2 | −0.1 | −0.2 | −0.9 | −0.2 |
| Day 4 | −13.1 | −11.8 | −4.7 | −0.2 | −0.1 | −0.3 | −1.3 | −0.2 |
| Day 5 | −35.8 | −30.8 | −9.3 | −0.4 | −0.2 | −1.0 | −1.8 | −0.8 |
| Day 6 | −56.9 | −51.8 | −15.9 | −1.1 | −0.4 | −1.1 | −2.5 | −1.0 |
| Day 7 | −100.0 | −100.0 | −33.8 | −1.4 | −0.7 | −2.4 | −3.3 | −1.8 |
| Day 10 | −100.0 | −100.0 | −100.0 | −1.6 | −0.9 | −2.4 | −6.9 | −1.9 |
| Day 17 | −100.0 | −100.0 | −100.0 | −1.7 | −1.2 | −2.5 | −10.0 | −2.2 |
| Day 34 | −100.0 | −100.0 | −100.0 | −13.5 | −1.6 | −10.6 | −19.7 | −7.6 |

E1 to E6 correspond to the invention, V1 and V2 are comparative formulations.

TABLE 2
Components used:

| EVA polymer 1 | | EVA, 18% VA content, melting point |
|---|---|---|
| | | 84-86° C., MFI 1.7 g/10 min (ASTM |
| | | D1238; 190° C., 2.16 kg) |
| Master | Peroxide | Dicumyl peroxide (active substance |
| batch | | 38-42 wt. %) |
| | blowing | Azodicarbonamide (ADCA) |
| | agent | |
| | Wax | Fischer-Tropsch wax, solidification |
| | | point 100° C., drip point: Minimum |
| | | 110° C., maximum 120° C. (determined |
| | | according to DGF M-III 3) |
| | EVA polymer 2 | EVA, 27-29% VA, MFI 400-600 g/10 min |
| | | (ASTM D1238; 190° C., 2.16 kg) |
| | Terpolymer | Ethylene-acrylic ester-glycidyl |
| | | methacrylate terpolymer, methyl |
| | | acrylate content 24 wt. %, glycidyl |
| | | methacrylate content 8 wt. %, melting |
| | | point 65° C., MFI 6 g/10 min |
| | | (190° C., 2.16 kg) |
| | Co-cross- | Trimethylolpropane triacrylate |
| | linking | (TMPTA) |
| | agent 1 | |
| | Co-cross- | Tricyclodecane dimethanol diacrylate |
| | linking | (TCDDA) |
| | agent 2 | |
| | Zinc oxide | Zinc oxide |
| | Antioxidant | Bis[3,3-bis-(4′-hydroxy-3′-tert- |
| | | butyl phenyl)butanoic acid]glycol ester, |
| | | molecular weight 794 g/mol, melting point |
| | | 167-171° C. |
| | Talc | Talc |
| | Dye | Dye concentrate |

1. A thermally expandable composition, containing, based on the total weight of the composition,
a) 40.0 to 98.0 wt. % of at least one peroxidically cross-linking polymer,
b) 0.05 to 5 wt. % of at least one peroxide,
c) 1.0 to 15.0 wt. % of at least one blowing agent, and
d) 0.1 to 10 wt. % of at least one wax,
wherein the at least one peroxidically cross-linking polymer has a melt flow index (MFI) of 0.3 to 10 g/10 min and is selected from styrene-butadiene block copolymers, styrene-isoprene block copolymers, ethylene-vinyl acetate copolymers, functionalized ethylene-vinyl acetate copolymers, functionalized ethylene-butyl acrylate copolymers, ethylene- propylene-diene copolymers, ethylene-methyl acrylate copolymers, ethylene-ethyl acrylate copolymers, ethylene-butyl acrylate copolymers, ethylene (meth)acrylic acid copolymers, ethylene-2-ethylhexyl-acrylate copolymers or ethylene-acrylic ester copolymers.

2. The thermally expandable composition according to claim 1, characterized in that the at least one peroxidically cross-linking polymer a) is an ethylene-vinyl acetate copolymer or a functionalized ethylene-vinyl acetate copolymer.

3. The thermally expandable composition according to claim 1, characterized in that the at least one peroxide is selected from di(tert-butylperoxyisopropyl)benzene, dicumyl peroxide, 1,1-di-(tert-butylperoxy)-3,3,5-trimethylcyclohexane, 2,5-dimethyl-2,5-di(tert-butylperoxy)hexane, dibenzoyl peroxide or di-tert-butyl-1,1,4,4-tetramethylbut-2-in-1,4-ylene diperoxide.

4. The thermally expandable composition according to claim 1, characterized in that the at least one blowing agent is selected from the group consisting of ADCA (azodicarbonamide), OBSH (4,4′-oxybis(benzenesulfonyl hydrazide)) and combinations thereof.

5. The thermally expandable composition according to claim 1, characterized in that the at least one wax is selected from a paraffinic wax having a melting temperature in the range from 45 to 70° C., a microcrystalline wax having a melting temperature in the range from 60 to 95° C., a synthetic Fischer-Tropsch wax having a melting temperature in the range from 90 to 115° C. or a polyethylene wax having a melting temperature between 85 and 140° C.

6. The thermally expandable composition according to claim 1, wherein the
at least one peroxidically cross-linking polymer contains glycidyl (meth)acrylate as a monomer in polymerized form; or one low molecular weight multifunctional acrylate; and/or
the constituents (b), (c), and (d) are used in a master batch.

7. A molded body, characterized in that the molded body comprises the thermally expandable composition according to claim 1.

8. A method for sealing and filling a void comprising preparing the thermally expandable composition according to claim 1 and introducing the thermally expandable composition in the void.

9. The method according to claim 8 further comprising heating the thermally expandable composition to a temperature above 130° C., thereby the thermally expandable composition expands and fills the void.

10. The molded body according to claim 7, which is an acoustic seal, water seal, or a moisture seal.
